(19) United States
(12) Patent Application Publication
(10) Pub. No.: US 2012/0060198 A1
(43) Pub. Date: Mar. 8, 2012

(54) METHOD AND SYSTEM FOR GENERATING METRICS REPRESENTATIVE OF POLICY AND CHARGING CONTROL RULES

(75) Inventors: Marc TREMBLAY, Montreal (CA); Eric Mélin, Montreal (CA)

(73) Assignee: NEURALITIC SYSTEMS, Montreal (CA)

(21) Appl. No.: 13/222,053

(22) Filed: Aug. 31, 2011

Related U.S. Application Data
(60) Provisional application No. 61/379,842, filed on Sep. 3, 2010.
(60) Provisional application No. 61/425,580, filed on Dec. 21, 2010.

(51) Int. Cl. G06F 21/00

(52) U.S. Cl. 726/1

(57) ABSTRACT

The present relates to a method and a system for generating metrics representative of Policy and Charging Control rules. The method and system analyzes, at a PCC rules analyzer, a Policy and Charging Control rule, to define at least one metric representative of the Policy and Charging Control rule. Then, the method and system transmits the at least one metric representative of the Policy and Charging Control rule, from the PCC rules analyzer to an analytic system. The method and system receives, at the analytic system, information representative of an IP data traffic occurring on an IP data network; and processes, at the analytic system, the information representative of the IP data traffic occurring on the IP data network, to calculate a value of the at least one metric representative of the Policy and Charging Control rule.

### BRIEF DESCRIPTION OF THE DRAWINGS

In the appended drawings:

FIG. 1 illustrates a system for generating metrics representative of Policy and Charging Control rules, according to a non-restrictive illustrative embodiment;

FIG. 2 illustrates a method for generating metrics representative of Policy and Charging Control rules, according to a non-restrictive illustrative embodiment;

FIG. 3 illustrates an analysis of a Policy and Charging Control rule to define a related metric, according to a non-restrictive illustrative embodiment;

FIG. 4 illustrates a system for generating metrics representative of Policy and Charging Control rules, according to a non-restrictive illustrative embodiment;

FIG. 5 illustrates a system architecture of an analytic system for generating metrics representative of Policy and Charging Control rules, according to a non-restrictive illustrative embodiment;

FIG. 6 illustrates a method for generating metrics representative of Policy and Charging Control rules, according to a non-restrictive illustrative embodiment.

### DETAILED DESCRIPTION

The volume of IP (Internet Protocol) data traffic on IP data networks is increasing continuously, due to various factors, including: the variety of devices available to connect to IP data networks, the variety of applications and data services available via the IP data network infrastructure, and the variety of usage patterns of the users consuming IP data services. For network Operators, this regular increase in the volume of IP data traffic has a direct impact on their network infrastructure: it must be upgraded regularly, in order to maintain the capacity of the network infrastructure to transport the IP data traffic with an appropriate level of service (in terms of Quality of Service, Service Level Agreements, end user experience, etc). Thus, the cost related to the maintenance/upgrade of the network infrastructure has a tendency to increase, while the revenues have a tendency to stagnate, or even decrease. This is particularly true for mobile networks, where the constraints in terms of network capacity and radio bandwidth are very strict; but it is also applicable (to a lesser extent) to fixed broadband networks.

Additionally, there is a growing tendency for content providers to bypass network Operators in the Internet value chain. Content providers generate revenues from their content, without compensating the network Operators for the usage of their network infrastructure (for the delivery of content or value added services to end users). This phenomenon is well known as the transformation of the network infrastructure in a “dump pipe”. This phenomenon is applicable to any kind of network Operator, including mobile Operators as well as Internet Service Providers (operating a fixed broadband network).

To respond to these challenges, network Operators are deploying a Policy and Charging Control (PCC) infrastructure. A set of PCC rules is defined, for instance at a Policy and Charging Rules Function (PCRF). The PCC rules are transmitted to dedicated networking equipments, for instance networking equipments implementing a Policy and Charging Enforcement Function (PCEF). The networking equipments enforce the PCC rules on the IP data traffic under their control. The PCC rules enable the enforcement of policy control: apply different policies (block, prioritize, throttle, etc) based on specific characteristics of the IP data traffic. The PCC rules also enable the enforcement of charging control: apply different charging schemes based on specific characteristics of the IP data traffic.

However, the PCC infrastructure does not include a mechanism to measure the impact on the IP data traffic, of applying these PCC rules. For instance, there is no mechanism to measure relevant characteristics of the IP data traffic occurring on the IP data network, before and after the enforcement of specific PCC rules, in order to assess the impact of these PCC rules (via the comparison of the measures before and after the enforcement of the PCC rules).

Also, the PCC infrastructure does not include a mechanism, to evaluate a potential impact on the IP data traffic of applying specific PCC rules. The PCC rules are applied to the targeted IP data traffic, and the impact of the PCC rules is observed a-posteriori. There is no mechanism to estimate (a-priori) the potential impact of the PCC rules, before effectively enforcing them.

Thus, there is a need of overcoming the above discussed limitations, concerning the lack of availability of an evaluation of the impact of applying Policy and Charging Control rules on the IP data traffic of an IP data network. An object of the present method and system is therefore to generate metrics representative of Policy and Charging Control rules.

In a general embodiment, the present method is adapted for generating metrics representative of Policy and Charging Control (PCC) rules. For doing so, the method analyzes, at a PCC rules analyzer, a Policy and Charging Control rule to define at least one metric representative of the Policy and Charging Control rule. Then, the method transmits the at least one metric representative of the Policy and Charging Control rule from the PCC rules analyzer to an analytic system. The method receives, at the analytic system, information representative of an IP data traffic occurring on an IP data network. And the method processes, at the analytic system, the information representative of the IP data traffic occurring on the IP data network, to calculate a value of the at least one metric representative of the Policy and Charging Control rule.

In another general embodiment, the present system is adapted for generating metrics representative of Policy and Charging Control (PCC) rules. For doing so, the system comprises a PCC rules analyzer: for analyzing a Policy and Charging Control rule to define at least one metric representative of the Policy and Charging Control rule; and for transmitting the at least one metric representative of the Policy and Charging Control rule to an analytic system. The system also comprises an analytic system: for receiving the at least one metric representative of the Policy and Charging Control rule from the PCC rules analyzer; for receiving information representative of an IP data traffic occurring on an IP data network; and for processing the information representative of the IP data traffic occurring on the IP data network, to calculate a value of the at least one metric representative of the Policy and Charging Control rule.

In one specific aspect of the present method and system, a timestamp of enforcement of the Policy and Charging Control rule to the IP data network is associated to the at least one metric representative of the Policy and Charging Control rule. A first value of the at least one metric is calculated for information representative of the IP data traffic occurring on the IP data network before the timestamp. A second value of the at least one metric is calculated for information representative of the IP data traffic occurring on the IP data network after the timestamp. The first value and the second value of the at least one metric are compared, to measure the impact of the enforcement of the Policy and Charging Control rule on the IP data traffic occurring on the IP data network.

In another specific aspect of the present method and system, the Policy and Charging Control rule is a candidate for enforcement to the IP data network. The value of the at least one metric representative of the Policy and Charging Control rule is representative of the potential impact of the enforcement of the Policy and Charging Control rule on the IP data traffic occurring on the IP data network.

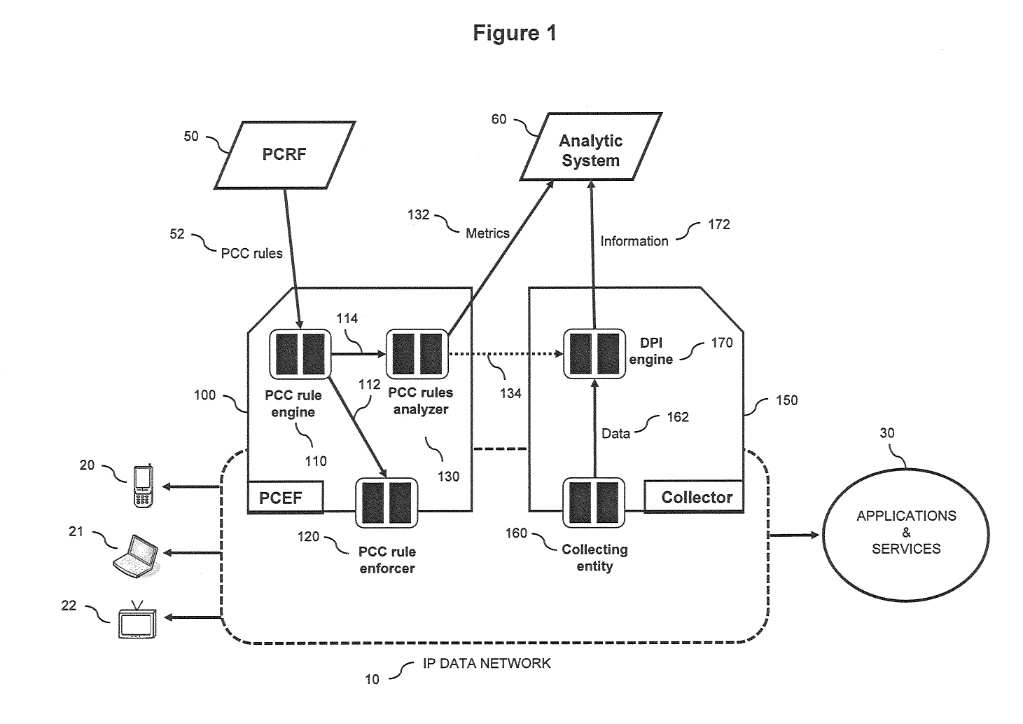

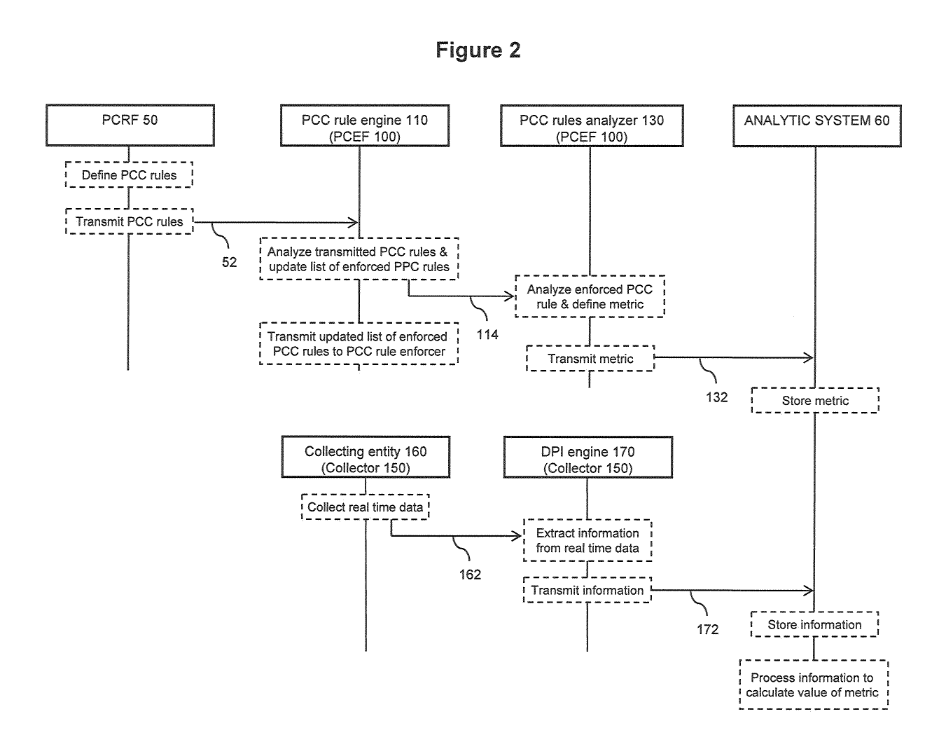

Now referring concurrently to FIGS. 1 and 2, a method and system for generating metrics representative of Policy and Charging Control rules will be described.

An IP data network 10 is represented in FIG. 1. It consists of an entire data network, or alternatively of only a section of a larger data network, where the IP protocol is used for the network layer (in reference to the Open Systems Interconnection (OSI) model). It allows various types of devices [20, 21, and 22] to access IP based applications and services 30, via the IP data network 10. For this purpose, IP data traffic (not represented in FIG. 1) is generated over the IP data network 10, between the devices [20, 21, and 22] and the infrastructure supporting the IP based applications and services 30.

The present method and system is applicable to any type of mobile IP network operated by a mobile network Operator, including without limitations: General Packet Radio Service (GPRS) networks, Universal Mobile Telecommunications System (UMTS) networks, Long Term Evolution (LTE) networks, Code Division Multiple Access (CDMA) networks, or Worldwide Interoperability for Microwave Access (WIMAX) networks.

The present method and system is also applicable to any type of IP based fixed broadband network operated by an Internet Service Provider (ISP), including without limitations: Digital Subscriber Line (DSL) networks, cable networks, or optical fiber networks.

By extension, the present method and system is applicable to any combination of a mobile IP network and an IP based fixed broadband network, in the context of a network Operator operating a converged mobile/fixed broadband network.

The present method and system is also applicable to an IP data network 10 operated by a corporation, for instance a private company or a governmental/public organization.

Various types of devices may be used to consume IP based applications and services 30, via the IP data network 10. Such devices include: mobile devices 20 in their broad sense (feature phones, smart phones, tablets, etc), computers 21 in their broad sense (desktops, laptops, netbooks, etc), and television sets 22. Such devices include any type of IP enabled mobile/fixed device, and any type of home networking equipment/IP enabled multimedia equipment. Based on the underlying access technology (mobile, fixed broadband, etc) of a specific IP data network 10, only a subset of the previously mentioned types of devices [20, 21, and 22] may be used. However, due to the convergence of the IP data networks 10 (specifically fixed and mobile convergence), more and more types of devices [20, 21, and 22] may be used to seamlessly access various types of IP data networks 10.

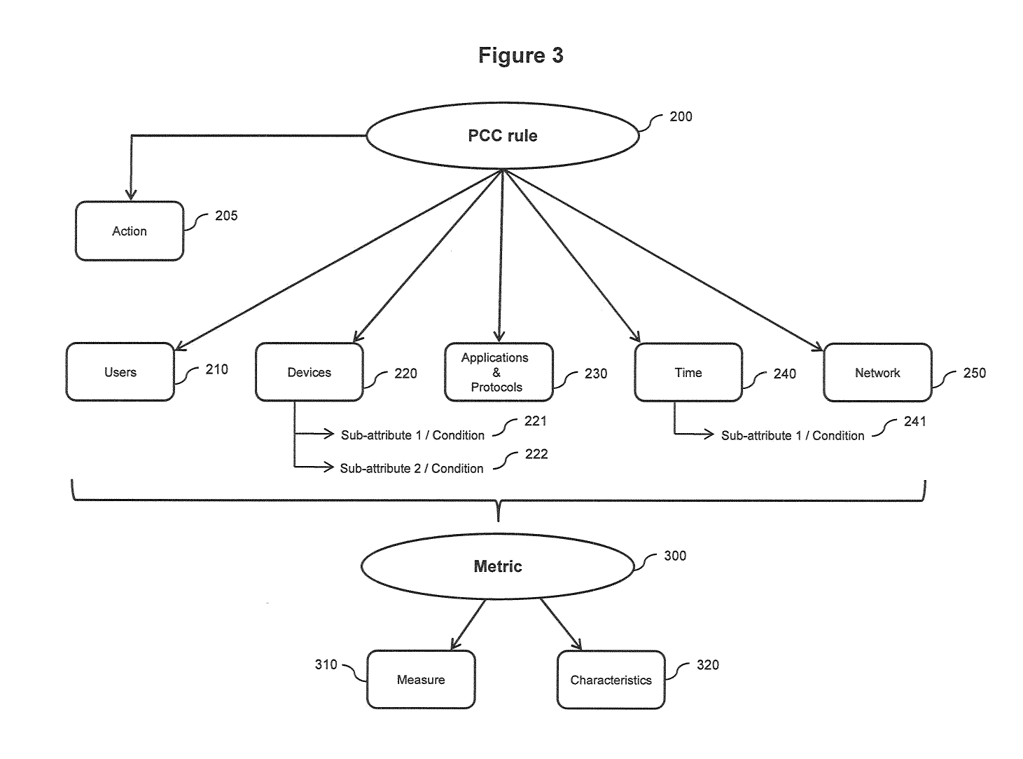

A Policy and Charging Control (PCC) infrastructure is also represented in FIG. 1. A Policy and Charging Rules Function (PCRF). 50 is an entity where PCC rules are defined. The PCRF is (generally) a standalone equipment, dedicated to the definition of PCC rules. Alternatively, the PCRF may be a functionality integrated in an existing networking equipment/management server. A PCC rule includes a set of attributes (at least one) related to the IP data traffic on the IP data network 10. Examples of such attributes include: time attributes (e.g. time in the day, day of the week, etc), user attributes (e.g. subscribed data plan, including for instance monthly total volume of data, and instant bandwidth (the instant bandwidth is defined as the total volume of IP data traffic allowed over a one second interval)), applications and protocols attributes (e.g. Peer-to-Peer (P2P) protocols or Voice over IP (VoIP) applications). FIG. 3 will illustrate other types of attributes applicable to a PCC rule. For each attribute, a PCC rule usually includes a (several) specific condition(s) to be met. An example of condition related to a time attribute is: the day is Saturday or Sunday, the time in the day is between 9h00 am and 5h00 pm. An example of condition related to a user attribute is: the instant bandwidth of a user is higher than 1 Mb/s. An example of condition related to an applications and protocols attribute is: the IP protocol related to an IP flow is the BitTorrent protocol. Then, one or several actions are associated to a PCC rule: once one or a set of conditions (associated to attributes defined in the PCC rule) is met, the one or several actions are executed. In the context of a policy control rule, an action may consist in: blocking specific IP flows, applying a particular Quality of Service (QoS) to specific IP flows (the effect of this particular QoS being either to increase or decrease the priority of these specific IP flows, based on the expected effect on the targeted IP data traffic). In the context of a charging control rule, an action may consist in: applying a particular charging scheme to specific IP flows (no charge, premium fee, discount fee, charging per time spent, charging per volume of IP data, etc).

The usual definition of an IP flow is considered in the present method and system as follows: a source IP address and source port, a destination IP address and destination port, and a transport protocol (in most cases, Transmission Control Protocol (TCP) or User Datagram Protocol (UDP)).

The definition of PCC rules at the PCRF 50 level potentially involves several components. First, a management user interface (not represented in FIG. 1) operated by staff of the network Operator, to manage (create/upgrade/delete) PCC rules. Then, an interface (not represented in FIG. 1) to Applications Servers; for instance, to a Serving Call Session Control Function (S-CSCF) in an IP Multimedia Subsystem (IMS) context. This interface is used to manage dynamic PCC rules, in relation to specific applications (with specific QoS needs and/or specific charging characteristics) being used on the IP data network 10. Also, an interface (not represented in FIG. 1) to a Subscriber Data Management server (for instance, a Subscription Profile Repository (SPR) in the case of an UMTS or LTE cellular network), to retrieve information related to subscribers' profiles (data plans, subscribed premium services, etc). This interface is used for the definition of subscriber related PCC rules. Other interfaces to additional networking equipments and servers may be used as well, to define PCC rules.

The PCRF 50 transmits the PCC rules 52 to a networking equipment 100, in charge of the enforcement of the PCC rules on the IP data traffic of the IP data network 10. For illustration purposes, a PCEF 100 is represented in FIG. 1, as an example of such a networking equipment in charge of the enforcement of the PCC rules 52. The terminology PCEF is usually used in the context of mobile networks. The PCEF is either a standalone networking equipment, dedicated to the enforcement of PCC rules. Alternatively, the PCEF is a functionality integrated in an existing networking equipment; for instance in a Gateway GPRS Support Node (GGSN) in an UMTS network, or in a Packet Data Network Gateway (P-GW) in a LTE network. In the context of a fixed broadband network, another terminology may be used in place of PCEF, to designate the same type of equipment/functionality. For simplification purposes, the term PCEF will be used in the rest of the description, as a generic name for the equipment/functionality in charge of the enforcement of the PCC rules.

A PCC rules engine 110 is a component of the PCEF 100, in charge of maintaining a coherent list of enforced PCC rules. When receiving a new list of PCC rules 52 from the PCRF 50, the PCC rules engine 110 analyzes this new list of PCC rules 52, in view of its current list of enforced PCC rules. The PCC rules engine 110 takes into account the different priorities which may be allocated to specific PCC rules, resolves conflicts between potentially conflicting PCC rules, eliminates potentially duplicate PCC rules, and generates an updated list of enforced PCC rules.

The updated list of enforced PCC rules is transmitted 112 to a PCC rules enforcer 120. The PCC rules enforcer 120 is a component of the PCEF 100, in charge of effectively applying the current list of enforced PCC rules to the IP data traffic of the IP data network 10 under its direct control. The precise mechanisms implemented by the PCC rules enforcer 120 are out of the scope of the present method and system. However, their impact on the IP data traffic has already been mentioned. A policy control rule has one of the following impacts: the IP data packets of specific IP flows are dropped, the IP data packets of specific IP flows are granted a specific priority (resulting in an increased or decreased priority in comparison to other IP flows), etc. Additionally, the policy control rule may be applied at specific periods of time, and/or for users with specific characteristics (e.g. subscribers with particular data plan characteristics), and/or when specific network conditions occur (e.g. congestion). This, in turn, has an impact on the type of applications and services used, the frequency of use, the time of use during the day, etc. A charging control rule has one of the following impacts: users are encouraged to increase their usage of specific applications and services, and to reduce their usage of other specific applications and services; users are encouraged to use specific applications and services at determined periods of time during the day, etc.

Generally speaking, the enforcement of the PCC rules by the PCC rules enforcer 120 has a significant impact on the characteristics of the IP data traffic occurring on the IP data network 10. And in most cases, this impact cannot be fully predicted (too many parameters should be taken into consideration; including the behavior of a large number of users, which is influenced by the enforcement of the PCC rules). Thus, it is the purpose of the present method and system to provide metrics (directly related to the enforced PCC rules) to measure this impact.

The list of enforced PCC rules is transmitted 114 from the PCC rules engine 110 to a PCC rules analyzer 130. The PCC rules analyzer 130 is a component of the PCEF 100, in charge of analyzing the enforced PCC rules, and defining metrics representative of these enforced PCC rules. The value of a metric is calculated by processing specific information extracted from the IP data traffic occurring on the IP data network 10. A metric is therefore representative of a particular aspect of the IP data traffic occurring on the IP data network 10. Thus, by defining a metric properly, in relation to the corresponding PCC rule(s), this metric can be used to measure the impact of the corresponding PCC rule(s) on the IP data traffic occurring on the IP data network 10. The definition of a metric, based on a corresponding PCC rule(s), will be further detailed later, in relation to FIG. 3.

The metrics 132, defined by the PCC rules analyzer 130, are transmitted to an analytic system 60. The analytic system 60 is represented as a standalone entity in FIG. 1. It is in charge of calculating the values of the metrics, based on the information extracted from the IP data traffic occurring on the IP data network 10 by a collector 150.

The collector 150 is represented as a standalone entity in FIG. 1. It comprises two sub-components: a collecting entity 160 and a DPI engine 170. The collecting entity 160 collects data in real time from the IP data traffic occurring on the IP data network 10: The collected data typically consists in IP packets, with a timestamp of their capture. The collected data 162 is processed by the DPI engine 170, to extract information 172, which is then transmitted to the analytic system 60.

A DPI engine is well known in the art. It is capable of recognizing which IP packets correspond to a specific IP flow, to identify the protocols used for this IP flow (usually several protocols corresponding to the various layers of the OSI model), and to extract parameters representative of a particular protocol from the IP packets. Based on this information, the application executed on a device [20, 21, and 22], and corresponding to this IP flow, is identified. A DPI engine is also capable of identifying the device [20, 21, and 22] which generated a specific IP flow, and to collect network information related to the device [20, 21, and 22] (e.g. localization of the device). Additionally, for sophisticated applications executed on the devices [20, 21, and 22], the DPI engine is capable of identifying and correlating several IP flows (with potentially various protocols) generated by the same application. The DPI engine is also capable of measuring the size of the IP packets which constitute a specific IP flow, allowing the calculation of the volume of IP data traffic generated by a specific application (the aggregated volume of IP data traffic per application constitutes an example of metric, calculated by the analytic system 60, based on the information 172 transmitted by the DPI engine 170).

The information 172 extracted by the DPI engine 170 may be stored temporarily in a flat file or in any other appropriate format, and transmitted at regular intervals (via the flat file or other appropriate format) to the analytic system 60. A typical analytic system 60 includes a database (not represented in FIG. 1), where the information 172 transmitted by the DPI engine 170 is stored. The transmitted information 172 is usually pre-processed by a processing unit (not represented in FIG. 1), to be adapted to a specific data model, before being stored in the database. A typical analytic system 60 also includes an analytic engine (not represented in FIG. 1). The analytic engine calculates the values of the metrics: when a specific metric is selected, the appropriate information is extracted from the database where it has been stored, and this information is processed to calculate the metric.

In a standard implementation, a single centralized PCRF 50 is deployed to control an entire IP data network 10 (for instance an entire mobile network or a fixed broadband network). Then, one or potentially several PCEF(s) are deployed and controlled by the centralized PCRF. Based on the topology of the IP data network 10 and its size, it is usually necessary to deploy several PCEFs to control several network segments of the IP data network 10. For instance, in an UMTS mobile network, several GGSNs are usually deployed. Thus, if the PCEF is a functionality embedded in the GGSNs, then several instances of the PCEF functionality 100 are deployed (one per GGSN). Since a PCEF enforces PCC rules on the network segment directly under its control, a collector 150 is deployed in association with the PCEF 100, to capture IP data traffic occurring on the network segment controlled by the corresponding PCEF 100. Usually, a single centralized analytic system 60 is deployed. This centralized analytic system 60 calculates metrics based on the information 172 transmitted by all the collectors 150 under its control.

If several PCEFs 100 are deployed in the IP data network 10, it may not be necessary to systematically deploy several collectors 150. A network Operator may consider that a single collector 150 corresponding to a particular PCEF 100 is sufficient, to measure the impact of the PCC rules on the IP data traffic of the IP data network 10. In this case, the information 172 transmitted by the single collector 150 to the analytic system 60 is considered as a representative sample of the IP data traffic occurring on the IP data network 10. Alternatively, a subset (more than one) of all the PCEFs 100 deployed in the IP data network 10 may be considered as sufficiently representative, and a set of corresponding collectors 150 may be deployed, to generate the information 172 necessary to calculate the values of the metrics 132 at the analytic system 60.

In another aspect, all PCEFs 100 in an IP data network 10 enforce the same set of PCC rules 52, defined by a centralized PCRF 50. In the case where different sets of PCC rules 52 (defined by the centralized PCRF 50) are enforced by different PCEFs 100; then each set of metrics 132, defined by a PCC rules analyzer 130, only applies to a specific set of PCC rules 52 enforced by a corresponding specific PCEF 100. And the values corresponding to this specific set of metrics 132 are calculated by the analytic system 60, exclusively for the information 172 transmitted by a specific collector 150, associated to the specific PCEF 100 enforcing the specific set of PCC rules 52.

In yet another aspect, the PCEF 100 may also have a set of static PCC rules. The static PCC rules may be less dynamic, by contrast to the PCC rules defined by the PCRF 50, which are more dynamic. In this case, the enforced PCC rules are a combination of the static PCC rules of the PCEF 100, and the PCC rules 52 transmitted by the PCRF 50. The PCC rules analyzer 130 generates the metrics 132 from the enforced PCC rules resulting from this combination.

In a different aspect of the present method and system, the PCEFs 100 and the collectors 150 are not collocated. For instance, the collecting entity 160 of a specific collector 150 may capture IP data traffic from a segment of the IP data network 10 different from the segment of the IP data network 10 where a corresponding PCEF 100 enforces PCC rules 52. The only requirement is that the PCC rules 52 enforced by the PCEF 100 have an impact on the IP data traffic of the segment of the IP data network 10 under the supervision of the collector 150.

Generally speaking, the localization of various entities represented in FIG. 1 (e.g. PCRF 50, PCEF 100, PCC rules analyzer 130, collector 150) may vary significantly, without changing the scope of the present method and system.

Firstly, although the PCC rules analyzer 130 has been represented as a component of the PCEF 100, alternatively the PCC rules analyzer 130 may be a component of the PCRF 50. In such an implementation, the PCRF 50 keeps a record of the enforced PCC rules for each PCEF 100. Also, a set of metrics 132 transferred from the PCC rules analyzer 130 to the analytic system 60 refers to a specific PCEF 100 (where the enforced PCC rules are effectively enforced). Then, the analytic system 60 associates the referenced PCEF 100 with the corresponding collector 150, and calculates the values of the metrics 132 based on the information 172 transmitted by the corresponding collector 150.

Secondly, the functionalities of the collector 150 may be integrated in the PCEF 100. The rationale for such an implementation resides in that the PCC rules enforcer 120 may implement (or at least use) the following functionalities to apply the enforced PCC rules to the IP data traffic: a collecting entity 160 (to collect the IP packets from the IP data traffic), and a DPI engine 170 (to determine which IP packets shall be applied a specific PCC rule).

In a particular aspect, the PCC rules analyzer 130 transmits 134 requirements to the DPI engine 170, to specify which information shall be extracted from the data 162 by the DPI engine 170. The objective of this aspect is to make sure that the information 172 transmitted to the analytic system 60 is adequate, to calculate the value of the metrics 132 defined by the PCC rules analyzer 130. Examples of such requirements are: the information 172 extracted from each IP flow shall include an identifier of the related device [20, 21, and 22], the information 172 extracted from each IP flow shall include the applicative protocols, the information 172 extracted from each IP flow shall be marked with a timestamp of occurrence, etc. The transmission of the requirements 134 is optional. For instance, in the case where the analytic system 60 has been deployed for the general purpose of monitoring the IP data network 10, the processing of the metrics 132 defined by the PCC rules analyzer 130 may be considered as a sub-function of the analytic system 60. And this sub-function may be adequately fulfilled with the generic set of information 172 transmitted by the DPI engine 170 to the analytic system 60.

Now referring concurrently to FIGS. 1 and 3, an analysis of a Policy and Charging Control rule to define a related metric will be described.

As illustrated in FIG. 3, a PCC rule 200 is constituted of at least one among a pre-defined set of attributes. The following attributes are represented in FIG. 3: users 210, devices 220, applications and protocols 230, time 240, and network 250. These attributes only constitute examples, and additional/different attributes may be defined without changing the scope of the present method and system.

Each attribute (210, 220, 230, 240, and 250) illustrated in FIG. 3 may be composed of a number of sub-attributes (for example, sub-attributes 221 and 222 for attribute 220, and sub-attribute 241 for attribute 240—all sub-attributes are not represented in FIG. 3 for simplification purposes). For each sub-attribute, a condition is defined. The condition generally consists in a value, or a range of values, to be reached by the sub-attribute. An action 205 (potentially a list of actions) is also defined for each PCC rule: when all the sub-attributes constituting a PCC rule have reached their respective conditions, the action(s) 205 is enforced on the IP data network 10 by the PCC rules enforcer 120.

Following are examples of sub-attributes for each attribute (210, 220, 230, 240, and 250) represented in FIG. 3. These sub-attributes only constitute examples, and additional/different sub-attributes may be defined without changing the scope of the present method and system.

Considering the attribute users 210, the sub-attributes (221 and 222) may be defined for example as follows: the profile of the user (e.g. bronze, silver, gold, platinum), the volume of data granted per month (x Giga-bytes), the maximum instant bandwidth authorized (y Mega-bits per second downstream−z Mega-bits per second upstream), etc. Thus, a PCC rule may contain one (or several) of the following sub-attribute/condition pairs: users with profile gold, users with more than 20 Giga-bytes granted per month, users with an authorized, instant bandwidth of more than 2 Mega-bits per second downstream.

The attribute corresponding to devices 220 is of particular interest in a mobile network environment. Examples of sub-attributes for the attribute devices 220 may be defined for example as follows in the context of a mobile network: the type of mobile device (feature phone, smart phone, portable computer, tablet, etc), the manufacturer of the mobile device (manufacturer X, manufacturer Y, etc), the model of the mobile device (model x, model y, model z, etc), etc. Thus, a PCC rule may contain one (or several) of the following sub-attribute/condition pairs: devices of type smart phone, devices from manufacturer X, devices of model x or y.

With respect to the attribute corresponding to applications & protocols 230, the following examples of sub-attributes may be applied: the type of protocol (e.g. Hyper Text Transfer Protocol (HTTP), BitTorrent, Real-time Transport Protocol (RTP), Real Time Streaming Protocol (RTSP), Session Initiation Protocol (SIP), etc), the type of application (e.g. web browsing, VoIP, peer-to-peer, emailing, etc), etc. Thus, a PCC rule may contain one (or several) of the following sub-attribute/condition pairs: protocol of type RTSP, application of type VoIP.

Since the identification of a type of application is usually performed via the DPI engine, and is highly dependent on the definition of the application type (which protocols and which specific parameters in an IP flow qualify this IP flow to be associated to the application type in question), the PCEF 100 and the Collector 150 shall have the capability to detect a common set of application types. This also applies to the protocols: if the PCEF 100 is capable of detecting a specific protocol defined in the PCC rule 52, but the Collector 150 is not capable of detecting this protocol; then the analytic system 60 may not be capable of calculating the value of the metric 132 defined by the PCC rules analyzer 130, based on the information 172 extracted by the Collector 150. Thus, the PCEF 100 and the Collector 150 may need to be synchronized (specify which protocols and applications they shall both be capable of identifying) to operate properly. Or in a preferred implementation, they may share the same DPI engine 170.

An additional sub-attribute may be defined for the attribute applications & protocols 230: the type of content. For example, in the context of a PCC rule to block an HTTP access to a specific web page, or to an entire web site, the type of content is the URL of the specific web page, or the URL of the entire web site, respectively.

Considering the attribute time 240, it may be refined in the following examples of sub-attributes: the days within a week (Monday to Sunday), the time slot within a day (from time 1 to time 2), etc. Thus, a PCC rule may contain one (or several) of the following sub-attribute/condition pairs: IP data traffic occurring on Saturdays and Sundays, IP data traffic occurring between 4 and 7 hours PM.

Considering the attribute network 250, it may be refined in the following examples of sub-attributes: the total instant bandwidth of the IP data traffic (instant bandwidth of all the IP data traffic occurring on the network segment under the control of the PCEF), the type of access network technology used by a device generating an IP flow (e.g. GPRS, UMTS, LTE, CDMA, WIMAX—in the context of a mobile network), the location of a device generating an IP flow (e.g. cell ID—in the context of a mobile network), etc. Thus, the PCC rule may contain one (or several) of the following sub-attribute/condition pairs: total instant bandwidth of the IP data traffic (on the network segment under the control of the PCEF) exceeding 50 Giga-bytes per second, IP flows generated by a mobile device using the access technology UMTS, IP flows generated by a mobile device located in cell IDs x, y, and z.

The PCC rules analyzer 130 analyzes the PCC rule 200, and defines a corresponding metric 300. A metric is composed of a measure 310; and of characteristics 320 of the measure 310, which define the scope of the measure to be calculated. Examples of measures 310 include: a volume of data, a number of users, a number of sessions, a session duration, etc. Each measure 310 is calculated by processing the information 172 extracted from the IP data traffic occurring on the IP data network 10 by the Collector 150. The characteristics 320 of the measure 310 define which information extracted from the IP data traffic is taken into account for the calculation, and how the measure 310 is calculated based on this information.

The PCC rules analyzer 130 analyzes the PCC rule 200 as follows. First, assuming the PCC rule contains a set of N attributes, the PCC rules analyzer identifies each attribute and determines its type (210, 220, 230, 240, and 250). Then, for each of the N attributes, the PCC rules analyzer determines among the sub-attributes defined for the type of attribute considered, the sub-attribute which applies to the attribute in question. Then, the analysis of each of the N pairs of sub-attribute/associated condition defines the measure 310 or/and a characteristic 320 of the measure 310. Additionally, the analysis of an action 205 associated to the PCC rule also defines the measure 310 or/and the characteristic 320 of the measure 310. Thus, the analysis of the PCC rule 200 generates one (or several) measures 310, with associated characteristic(s) 320. Each combination of the measure 310, with the associated characteristics 320, defines the metric 300.

Following is an example of one PCC rule 200 of the type policy control, and the related defined metric 300. The following PCC rule is considered: enforce a QoS rule to grant a high priority to IP flows related to a gaming application, generated by a device of manufacturer X, for users with a profile gold_gaming. The PCC rule is analyzed as follows. The action “enforce a QoS rule to grant a high priority to IP flows” has an impact on the volume of IP data traffic generated (a higher priority generates a better end user experience, which leads to an increased usage, and thus an increased volume), thus it is interpreted as the measure 310: volume of IP data traffic. The attribute “IP flows related to a gaming application” is an attribute of type applications & protocols 230. The sub-attribute is applications, and the condition is gaming application. It is interpreted as the characteristic 320: the IP data traffic to consider is of type gaming application. The attribute “generated by a device of manufacturer X” is an attribute of type devices 220. The sub-attribute is manufacturer of the device, and the condition is “manufacturer X”. It is interpreted as the characteristic 320: the IP data traffic to consider is generated by devices of the manufacturer X. The attribute “for users with a profile gold_gaming” is an attribute of type users 210. The sub-attribute is profile of the user, and the condition is “gold_gaming”. It is interpreted as the characteristic 320: the IP data traffic to consider is generated by users with a profile gold_gaming.

The resulting metric 300 is a combination of the measure 310 with the characteristics 320: volume of IP data traffic generated by IP flows corresponding to a gaming application, generated by devices of manufacturer X, and users with profile gold_gaming. For comparison purposes, the following metrics may also be defined: volume of IP data traffic for IP flows corresponding to a gaming application, generated by devices of manufacturer X, and users with profile different from gold_gaming. And: volume of IP data traffic for IP flows corresponding to a gaming application, generated by devices of all manufacturers except X (no constraint on profile).

The measure 310 of the volume of IP data traffic, for each of the aforementioned metrics 300, may be calculated in different ways: total volume of IP data traffic generated by the IP flows matching the characteristics 320, or average volume of IP data traffic per device generated by the IP flows matching the characteristics 320, etc.

In the previous example of one PCC rule 200, some characteristics 320 of the resulting metric 300 may or may not be extracted by the DPI engine 170, based on its capabilities. For instance, the manufacturer of a device generating an IP flow can be extrapolated from an identifier of the device (e.g. the Media Access Control (MAC) address, or the International Mobile Equipment Identity (IMEI) for a mobile device, etc), which can usually be extracted by the DPI engine 170. But the profile of a user is not available to the DPI engine 170. Thus, the analytic system 60 may have to interface with additional equipments (e.g. a SPR), to retrieve additional information related to a specific user or device, like the profile of a user or the manufacturer of a device. A unique identifier (e.g. an International Mobile Subscriber Identity (IMSI), or an IMEI), extracted by the DPI engine 170, is generally used as an identifier of the specific user or device, when interfacing with the additional equipment (e.g. with the SPR).

The analysis of the PCC rules 200 to define the metrics 300, performed by the PCC rules analyzer 130, may be implemented in different ways. A rule engine is an example of an appropriate technology for this purpose. A rule engine is considered as well known in the art. Generally speaking, a rule engine is capable of analyzing an input, using a pre-defined set of rules, and generating an output matching the input, based on the rules. Thus, a rule engine is an appropriate technology for implementing the functionalities of the PCC rules analyzer 130.

For this purpose, the rule engine includes a set of syntactic rules, representing the syntax of the PCC rules 200: actions (205), attributes (210, 220, 230, 240, 250, etc), sub-attributes and conditions (221, 222, 241, etc). The analysis of a PCC rule 200 by the rule engine consists in determining one or several matching syntactic rules; which are interpreted as corresponding measures 310, or characteristics 320 of a measure 31. The combination of one measure 310, and the associated characteristics 320, represents a metric 300.

Additionally, a timestamp is associated to each PCC rule 200, identifying the moment when the PCC rule has been enforced by the PCEF 100. This timestamp is also associated to the corresponding metric(s) 300, defined through the analysis of the PCC rule 200, by the PCC rules analyzer 130. Then, a first value of the metric(s) 300 is calculated (by the analytic system 60) for information 172 extracted before the timestamp by the collector 150. And a second value of the metric(s) is calculated (by the analytic system 60) for information 172 extracted after the timestamp by the collector 150. The first and second values of the metric are compared by the analytic system 60. For instance, the analytic system 60 may include a report generation unit. A report may be generated, representing the evolution of the first and second values over a period of time before and after the timestamp. The report may be displayed on a graphical user interface for the staff of the network Operator, to measure the impact of the enforcement of the PCC rule (evolution of the metric before and after the timestamp). As mentioned previously, the analytic system generally includes a database, where the information 172, indexed by timestamps, is stored for a pre-determined period of time. Thus, the relevant information is available in the database, allowing the calculation of the value of the metric over a period of time before and after the timestamp of enforcement of the PCC rule.

As another example of a PCC rule of the type policy control, the following PCC rule is proposed for a mobile network: limit the peer-to-peer IP data traffic to a maximum instant bandwidth of 10% of the global IP data traffic, every day between 9 AM and 6 PM, for users using a device of type portable computer or tablet. A metric defined by the PCC rules analyzer 130 after analysis of this PCC rule is: total volume of peer-to-peer IP data traffic between 9 AM and 6 PM, for users using a device of type portable computer or tablet. Another possible metric is: average instant bandwidth consumed by peer-to-peer applications on 15 minutes intervals between 9 AM and 6 PM, for users using a device of type portable computer or tablet. A report is generated for each metric, showing the value of the metric every day over a period of one month before and after the timestamp of enforcement of the PCC rule. The visualization of the reports allows the staff of the network Operator to measure the impact of the enforcement of the PCC rule in question on the IP data traffic of the IP data network 10.

Following is an example of a PCC rule 200 of the type charging control, and the related defined metric 300. The following PCC rule 200 is considered: apply charging based on the volume of IP data traffic generated by IP flows related to a specific video streaming application, generated by a device of manufacturer X, for users with a profile different from gold. The PCC rule 200 is analyzed as follows.

The action 205 “apply charging based on the volume of IP data traffic generated by IP flows” is interpreted as a measure 310 of a metric 300: volume of IP data traffic.

The attribute “related to a specific video streaming application is an attribute of type applications & protocols 230. The sub-attribute is applications, and the condition is the specific video streaming application. It is interpreted as a characteristic 320 of a metric 300: the IP data traffic to consider is of type specific video streaming application.

The attribute “generated by a device of manufacturer X” is an attribute of type devices 220. The sub-attribute is manufacturer of the device, and the condition is “manufacturer X”. It is interpreted as a characteristic 320 of a metric 300: the IP data traffic to consider is generated by devices of the manufacturer X.

The attribute “for users with a profile different from gold” is an attribute of type users 210. The sub-attribute is profile, and the condition is “not gold”. It is interpreted as a characteristic 320 of a metric 300: the IP data traffic to consider is generated by users who do not have a gold profile.

One resulting metric 300 of the combination of a measure 310 with characteristics 320 is: volume of IP data traffic, for IP flows corresponding to the specific video streaming application, generated by devices of the manufacturer X, for users with a profile different from gold. The value of the metric is calculated with a selected granularity of one day, and over a selected time period of one month.

Additionally, a combination of several PCC rules 200 may be analyzed by the PCC rules analyzer, to generate one (or several) metric(s) 300. By doing so, redundancies or inconsistencies in the definition of the metrics may be avoided. Also (when applicable), a global metric may be defined by the combination of the PCC rules, instead of several more targeted metrics related to individual PCC rules. This allows a high level vision of the impact of the PCC rules on the IP data network, instead of a fragmented perspective illustrated by various metrics.

For example, a set of PCC rules defining the maximum instant bandwidth allowed for peer-to-peer applications at various time slots of the day (each time slot is defined between two hours of the day, for instance 6 AM to 9 AM-9 AM to 12 AM, etc) for users with a specific profile (bronze, gold, etc) may be considered. Instead of defining a metric for each PCC rule addressing a specific time slot or a specific profile, a global metric can be defined as follows: average instant bandwidth of peer-to-peer IP data traffic on 5 minutes intervals, between 6 AM and 8 PM, segmented by the profile of the users.

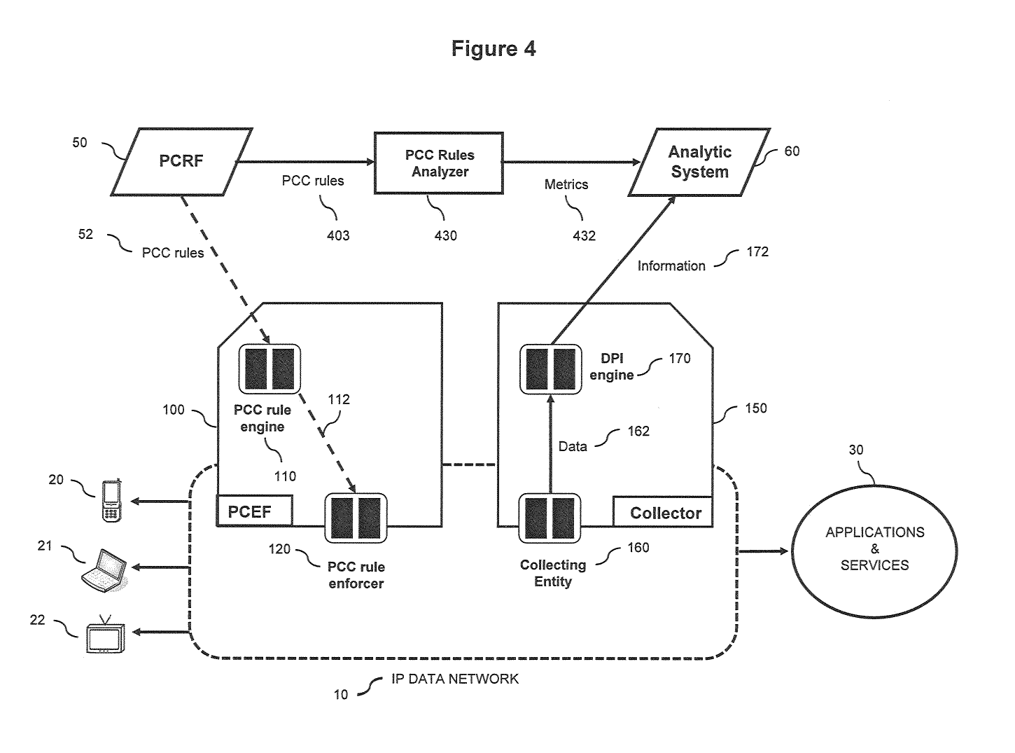

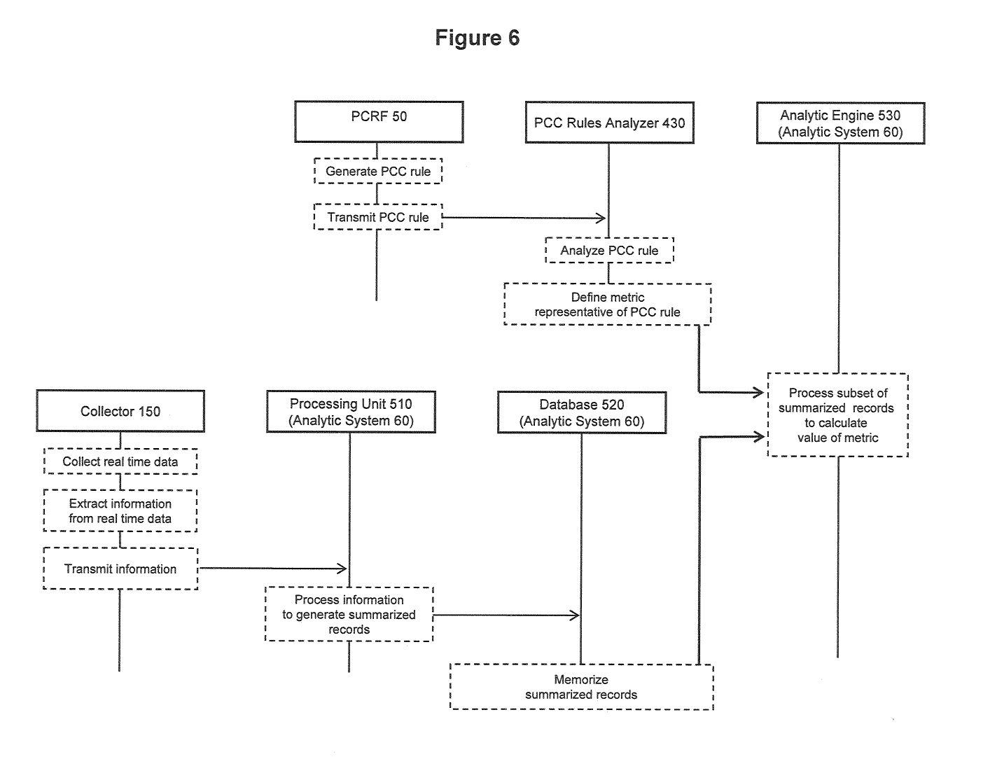

Now referring concurrently to FIGS. 4 and 6, another aspect of the method and the system for generating metrics representative of Policy and Charging Control rules will be described.

In the following, an alternative embodiment of the present method and system is described. FIG. 4 is similar to FIG. 1. The main difference is the localization of the PCC rules analyzer (130 in FIGS. 1 and 430 in FIG. 4). FIG. 1 is representative of a first use case: evaluating the impact of already enforced PCC rules (comparing the values of metrics representative of the PCC rules before and after the enforcement). FIG. 4 is representative of a second use case: evaluating the potential impact of candidate PCC rules (the candidate PCC rules have not been enforced yet; and historical information collected from IP data traffic occurring on an IP data network is used, to evaluate the potential impact of these candidate PCC rules on the IP data traffic occurring on the IP data network).

An IP data network 10 is represented in FIG. 4. It consists of an entire data network, or alternatively of only a section of a larger data network, where the IP protocol is used for the network layer (in reference to the Open Systems Interconnection (OSI) model). It allows various types of devices [20, 21, and 22] to access IP based applications and services 30, via the IP data network 10. For this purpose, IP data traffic (not represented in FIG. 4) is generated over the IP data network 10, between the devices [20, 21, and 22] and the infrastructure supporting the IP based applications and services 30.

An alternate PCC infrastructure is also represented in FIG. 4. The PCRF 50 is the entity where the PCC rules are defined. The PCRF is generally a standalone equipment, dedicated to the definition of the PCC rules. Alternatively, the PCRF is a functionality integrated in an existing networking equipment/management server. The PCC rule includes a set of attributes (at least one) related to the IP data traffic occurring on the IP data network 10. Examples of such attributes have already been described in relation to FIG. 1.

The PCRF 50 transmits the PCC rules 52 to a networking equipment 100, in charge of the enforcement of the PCC rules 52 on the IP data traffic occurring on the IP data network 10. For illustration purposes, a PCEF 100 is represented in FIG. 4, as an example of such a networking equipment, in charge of the enforcement of the PCC rules 52.

The PCC rules engine 110 is the component of the PCEF 100, in charge of maintaining a coherent list of enforced PCC rules. When receiving a new list of PCC rules 52 from the PCRF 50, the PCC rules engine 110 analyzes this new list of PCC rules 52, in view of its current list of enforced PCC rules. The PCC rules engine 110 takes into account the different priorities which may be allocated to specific PCC rules, resolves conflicts between potentially conflicting PCC rules, eliminates potentially duplicate PCC rules, and generates an updated list of enforced PCC rules. The updated list of enforced PCC rules is transmitted 112 to a PCC rules enforcer 120.

Generally speaking, the enforcement of the PCC rules by the PCC rules enforcer 114 has a significant impact on the characteristics of the IP data traffic occurring on the IP data network 10. And in most cases, this impact cannot be fully predicted (too many parameters should be taken into consideration; including the behavior of a large number of users, which is influenced by the enforcement of the PCC rules). A network Operator usually has access to reports illustrating the usage of applications and services 30 on the IP data network 10; and reports illustrating the behaviors of its subscribers (who own the devices [20, 21, and 22]) with respect to the usage of these applications and services 30. The network Operator also has access to reports illustrating the charging history of its subscribers (who own the devices [20, 21, and 22]). These various reports illustrate the consumption patterns of the subscribers, with respect to the applications and services 30, for the last days, last weeks, last months, etc. Based on these reports, the network Operator defines specific PCC rules 52, to be applied to the IP data network 10. These specific PCC rules 52 are expected to modify the consumption patterns of the subscribers, in order to reach specific marketing or network management objectives. However, the aforementioned reports may only help the network Operator in the definition of PCC rules; but these reports are not designed to help in the prediction of the potential impact of specific PCC rules on the IP data traffic occurring on the IP data network 10.

The PCC rules 52 are defined at the PCRF 50, and enforced by the PCEF 100. Then, based on the observed impact of the PCC rules 52 on the IP data traffic occurring on the IP data network 10, these PCC rules may be adapted, or new PCC rules may be defined. Thus, a process of “blindly applying”, and then “fine tuning”, may be required, to effectively reach the aforementioned specific marketing or network management objectives, via the enforcement of the PCC rules 52. However, these PCC rules 52 may have a non anticipated impact, which may be very damageable for the network Operator in terms of unexpected costs, lost revenues, or non-optimal network operations.

Thus, it is one purpose of the present method and system to provide a mechanism to the network Operator, for evaluating the potential impact of candidate PCC rules 52, before effectively enforcing them on the IP data traffic occurring on the IP data network 10.

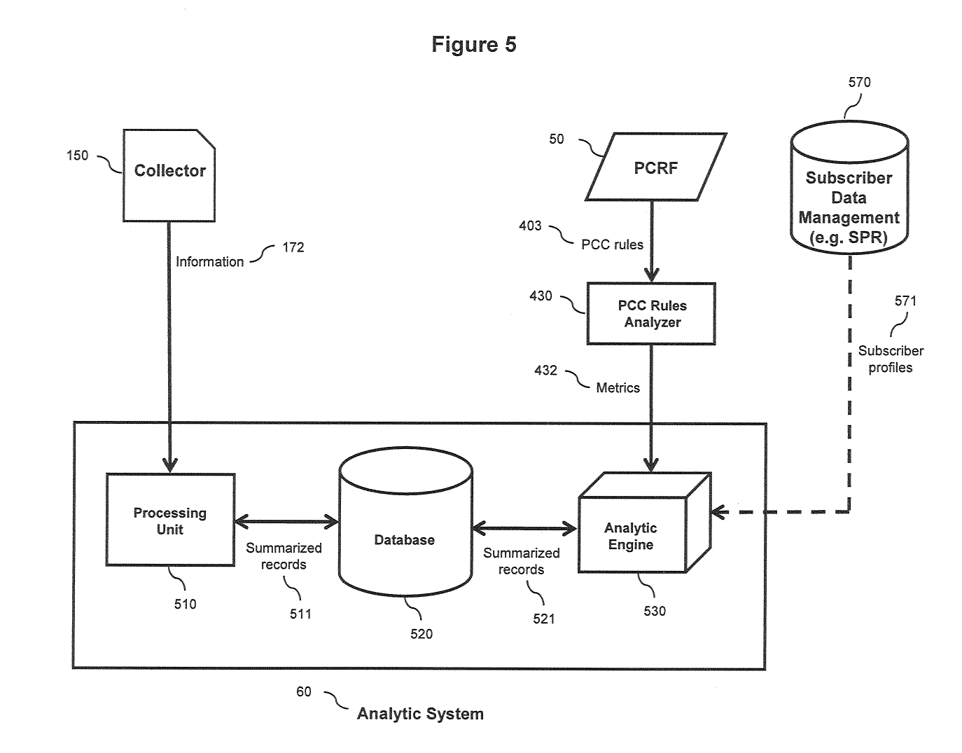

A candidate PCC rule 403 (candidate for enforcement on the IP data traffic occurring on the IP data network 10), defined at the PCRF 50, is transmitted to a PCC rules analyzer 430. The PCC rules analyzer 430 analyzes the candidate PCC rule 403, to define at least one metric 432 representative of the candidate PCC rule 403; and transmits this at least one metric 432 to an analytic system 60. The analytic system 60 calculates a value of the at least one metric 432, in order to evaluate the potential impact of the enforcement of the candidate PCC rule on the IP data traffic occurring on the IP data network 10. This evaluation is performed before the PCRF 50 transmits 52 the candidate PCC rule to the PCEF 100, for effective enforcement on the IP data traffic occurring on the IP data network 10. The analytic system 60 will be further detailed later in the description, in relation to FIG. 5. It provides a functionality to calculate the values of the metrics 432 representative of the PCC rules 403; based on information collected (and stored over a certain period of time) from the IP data traffic occurring on the IP data network 10, by at least one collector 150. A metric 432 is representative of a particular characteristic of the IP data traffic occurring on the IP data network 10. Thus, by defining a metric 432 properly, in relation to the corresponding candidate PCC rule(s) 403, the value of this metric 432 can be used to evaluate the potential impact of the candidate PCC rule(s) 403 on the IP data traffic occurring on the IP data network 10. The definition of a metric 432, based on a corresponding PCC rule(s) 403, has already been detailed in the description, in relation to FIG. 3.

The collector 150 is represented as a standalone entity in FIG. 4. It comprises two sub-components: the collecting entity 160 and the DPI engine 170. The collecting entity 160 collects data in real time from the IP data traffic occurring on the IP data network 10. The data collected in real time generally consists of IP packets, with a timestamp of the occurrence of their capture. The collected data 162 is transmitted to the DPI engine 170, where it is further processed to extract information. This information 172 is then transmitted, in the form of IP data records, to the analytic system 60. These IP data records may be stored temporarily for example in a flat file at the collector 150; and transmitted at regular intervals (e.g. every hour, every day, etc) to the analytic system 60.

For example, in the case of an UMTS (also GPRS or LTE) cellular network, the collector 150 may be positioned between a Serving GPRS Support Node (SGSN) and a Gateway GPRS Support Node (GGSN), in order to capture the IP data traffic between these two equipments. This IP data traffic is well known in the art as the GPRS Tunneling Protocol (GTP) control and user planes. For instance, a unique identifier of the device [20, 21, and 22] (International Mobile Equipment Identity (IMEI)), or of the subscriber owning the device [20, 21, and 22] (International Mobile Subscriber Identity (IMSI) or Mobile Subscriber Integrated Services Digital Network Number (MSISDN)), is extracted from the IP packets of the GTP control plane. And information related to the applications and services 30 consumed by the device [20, 21, and 22] is extracted from the IP packets of the GTP user plane.

In an alternative embodiment, the collector 150 does not operate on the real time IP data traffic occurring on the IP data network 10. The collector 150 collects data that have been gathered by one or several equipments of the IP data network 10. The gathered data usually consist in logs of the IP data traffic occurring on the IP data network 10. The same type of information is extracted from these gathered data, as in the case of the previously described embodiment (collecting entity 160 and DPI engine 170) of the collector 150. However, the granularity of the information may be lower in this second embodiment, since the collector 150 only extracts the subset of information present in the gathered data, and some useful information may be missing. Nevertheless, the extracted information may be sufficient to be representative of the IP data traffic occurring on the IP data network 10, since it usually includes: a unique identifier of a device [20, 21, and 22] (or of the subscriber owning the device [20, 21, and 22]); and several parameters representative of the applications and services consumed by the device [20, 21, and 22] (identification of each specific protocol/application, volume of IP data traffic generated by a specific protocol/application, timestamp of occurrence of a specific protocol/application, duration of usage of a specific protocol/application, etc).

In the case of a mobile network, such collected data are usually referred to as Call Detail Records (CDRs). For instance, in the case of an UMTS cellular network, the collector 150 retrieves the CDRs from network equipments such as the GGSN and the SGSN; and extracts the relevant information from these CDRs. In the case of a fixed broadband network, such collected data are usually referred to as IP Detail Records (IPDRs), and are retrieved by the collector 150 from various networking equipments, based on the specific fixed broadband technology considered.

The implementation/configuration of the collectors 150 shall ensure that the information 172 extracted and transmitted (in the form of IP data records) to the analytic system 60, is adequate to calculate the metrics representative of the candidate PCC rules 403 defined at the PCRF 50. For this purpose, the information shall meet the following exemplary requirements: the information extracted from each IP flow shall include an identifier of the related device [20, 21, and 22], the information extracted from each IP flow shall include the identification of the related protocols/applications, the information extracted from each IP flow shall be marked with a timestamp of occurrence, etc. These requirements are generally met by a collector 150, specifically when it is implemented by means of a DPI engine 170.

Now referring concurrently to FIGS. 4 and 5, a system architecture of an analytic system for generating metrics representative of Policy and Charging Control rules will be described.

In one embodiment of the present method and system, the analytic system 60, represented in FIG. 5, is composed of a processing unit 510, a database 520, and an analytic engine 530.

The information 172 collected by the collector 150 is received by the processing unit 510. Summarized records 511 are generated by the processing unit 510, based on the received information 172, and stored in the database 520. A new summarized record 511 may be created, based on the received information 172, and then stored in the database 520. Alternatively, an existing summarized record 511, already stored in the database 520, may be updated, based on the received information 172. The role of the processing unit 510 is also to adapt the received information 172 to a specific (optimized) data model, in order to store the received information 172 in the database 520 (in the form of the summarized records 511).

The received information 172 is representative of the IP data traffic occurring on the IP data network 10 represented in FIG. 4. For example, it includes: a unique identifier of a device (or of the subscriber owning the device); and several parameters representative of the applications and services consumed by this device (e.g. identification of each specific protocol/application, volume of IP data traffic generated by a specific protocol/application, timestamp of occurrence of a specific protocol/application, duration of usage of a specific protocol/application, etc).

A summarized record 511 represents an aggregated usage of a specific application or service, for a specific device (or subscriber) identified by its unique identifier, over a pre-defined period of time (e.g. every minute, every hour, every day, every week, etc). For example, a summarized record 511 for a specific device (or subscriber) over a one hour period of time includes: the unique identifier of the device (or the unique identifier of the subscriber who owns the device), the initial date and time of the one hour period of time, the specific protocol(s) and/or application used over this one hour period of time. A specific protocol identifies a specific IP networking protocol used in the context of an application (e.g. the SIP and RTP protocols for a VoIP application, the SIP and RTSP (Real Time Streaming Protocol) protocols for a video streaming application). A specific application identifies a specific instance of an application (e.g. Skype, Google voice, etc). The notion of service may also be introduced in the summarized records. A specific service represents one or several applications of the same type (e.g. VoIP service, video streaming service, messaging service, web browsing service, etc). Hence, usage of the application Linphone is represented in a summarized record 511 by: usage of the SIP and RTP protocols, usage of the VoIP application Linphone, and usage of the VoIP service. Parameters related to usage of an application are also stored in the summarized record 511: duration of the usage, volume of IP data traffic generated by the usage, etc. Additional parameters, specific to a particular application or a particular protocol, may also be recorded in the summarized records 511 (if the collector 150 has the capability to capture them). For example, the URLs in the case of the HTTP protocol, the size of the attachments in the case of an emailing application, etc.

The PCRF 50 transmits a candidate PCC rule 403 to the PCC rules analyzer 430. The candidate PCC rule 403 is analyzed by the PCC rules analyzer 430, to define at least one metric 432 representative of this candidate PCC rule. The definition of a metric has already been detailed in the description, in relation to FIG. 3.

The metric 432 is transmitted to the analytic engine 530. A value of the metric 432 is calculated by the analytic engine 530, based on the processing of the summarized records 521 present in the database 520. The value of the metric is representative of the potential impact of the candidate PCC rule 403 on the IP data traffic of the IP data network 10 represented in FIG. 4. The calculation of a value of a metric 432 may also comprise the processing of additional information (by the analytic engine 530), in conjunction with the processing of the summarized records 521 (the summarized records 521 are an optimized representation of the information 172 transmitted by the collector 150). For example, the additional information may consist in information (e.g. subscribers' profiles 571) from a Subscriber Data Management server 570 (e.g. a Subscription Profile Repository (SPR) in the context of an UMTS or LTE cellular network). The calculation of a value of a metric has already been detailed in the description, in relation to FIG. 3.

The processing unit 510, the PCC rules analyzer 430, and the analytic engine 530, are respectively composed of dedicated software programs executed on a dedicated computer. Alternatively, dedicated software programs corresponding to any combination of the processing unit 510, the PCC rules analyzer 430, and the analytic engine 530, may be executed on the same computer. The software and hardware implementations of the database 520, the collector 150, the PCRF 50, and the Subscriber Data Management entity 570, are considered as well known in the art. In a specific embodiment of the present method and system, the PCC rules analyzer 430 may be integrated as a component of the analytic system 60.

The calculation of the value of a metric representative of a Policy and Charging Control rule will now be described.

Each value of a metric 432, represented in FIG. 5, is calculated by the analytic engine 530. Summarized records 521, corresponding to the metric 432, are extracted from the database 520, and processed by the analytic engine 530, to calculate the value of the metric 432. For each metric 432, the measure and characteristics (respectively 510 and 520 as represented in FIG. 3) defining the metric 432 determine which summarized records 521 are extracted from the database 520, for the calculation of the value of this metric 432.

One type of Policy and Charging Control rule is a policy control rule. The value of a metric generated from this policy control rule is representative of the potential impact of this policy control rule on traffic characteristics of the IP data traffic occurring on the IP data network 10.

The other type of Policy and Charging Control rule is a charging control rule. The value of a metric generated from this charging control rule is representative of the potential impact of this charging control rule on charging characteristics of the IP data traffic occurring on the IP data network 10.

The following example of a candidate PCC rule 403 is thus used: enforce a QoS rule to grant a high priority to IP flows related to a specific gaming application, generated by a device of manufacturer X. A corresponding metric 432 is: volume of IP data traffic generated by IP flows corresponding to the specific gaming application, generated by devices of manufacturer X

The value of the aforementioned metric is calculated as follows. The value of this metric is calculated with a granularity of one hour, over a period of one week. The summarized records 521, stored in the database 520, include the volume of IP data traffic generated by each user, for each type of application; aggregated on an hourly basis (this aggregated volume is calculated by the processing unit 510, based on the received information 172). The analytic engine 530 queries the database 520, to obtain the aggregated volume of IP data traffic over a selected hour, for the application corresponding to the specific gaming application, and for the users who have a device from manufacturer X. For simplification purposes, an assumption that this information (manufacturer of the device owned by a user) is available in the database 520 is thus made. Otherwise, this information is obtained from an external source, like the Subscriber Data Management server 570. For the selected hour, all the aggregated volumes obtained from the query to the database 520 are added, to calculate the value of the metric: the (total) volume of IP data traffic, for IP flows corresponding to the specific gaming application, and generated by devices of the manufacturer X. The value of the metric is calculated for each hour within the selected week.

A report is generated by the analytic engine 530, representing the evolution of the value of each metric, over a selected period of reference. For example, a report is generated, to represent the evolution of the aforementioned metric (the volume of IP data traffic, for IP flows corresponding to the specific gaming application, and generated by devices of the manufacturer X), by intervals of one hour, over a selected weekly period of reference. The reports are displayed on a graphical user interface (which may be a component of the analytic engine 530) to end users (e.g. members of the staff of the network Operator), to evaluate the potential impact of the enforcement of the related candidate PCC rule 403. An end user may interact, via a user interface (not represented), with the analytic engine 530, to specify some parameters (e.g. the value of the intervals and the value of the period of reference for the calculation of the value of a metric). The definition of a metric defined by the PCC rules analyzer 430 may also be modified (e.g. modifying, adding, or removing, a characteristic 520 of FIG. 3) by an end user, for simulation purposes.

The analytic engine 530 may interface with external servers, to retrieve additional information for the calculation of the value of a metric 432. For example, a Subscriber Data Management server 570 contains information related to the subscribers, which may not be present in the database 520. In the aforementioned example of a candidate PCC rule, the attribute “for users with a profile gold” may be added. In this case, for each summarized record 521 retrieved from the database 520 (corresponding to the subset of the candidate PCC rule “enforce a QoS rule to grant a high priority to IP flows related to a specific gaming application, generated by a device of manufacturer X”), the analytic engine 530 queries the Subscriber Data Management server 570 to retrieve a subscriber profile 571, corresponding to the subscriber referenced in the summarized record 521. If the subscriber profile 571 indicates that the subscriber has a gold profile, the summarized record 521 is taken into consideration for the calculation of the value of the metric; otherwise it is not taken into consideration. A common (unique) identifier of the subscribers is used, to correlate the information in the database 520, with the information in the Subscriber Data Management server 570 (for example, in the case of an UMTS or LTE cellular network, the unique identifier is an IMSI or an MSISDN, and the Subscriber Data Management server 570 is a SPR).

Although the present method and system have been described in the foregoing specification by means of several non-restrictive illustrative embodiments, either in the singular or plural form, these illustrative embodiments can be modified at will without departing from the scope of the following claims.

What is claimed is:

1. A method for generating metrics representative of Policy and Charging Control (PCC) rules, the method comprising:
analyzing at a PCC rule analyzer a Policy and Charging Control rule to define at least one metric representative of the Policy and Charging Control rule;
transmitting the at least one metric representative of the Policy and Charging Control rule from the PCC rule analyzer to an analytic system;
receiving at the analytic system information representative of an IP data traffic occurring on an IP data network;
processing at the analytic system the information representative of the IP data traffic occurring on the IP data network, to calculate a value of the at least one metric representative of the Policy and Charging Control rule.

2. The method of claim 1, wherein a timestamp of enforcement of the Policy and Charging Control rule to the IP data network is associated to the at least one metric representative of the Policy and Charging Control rule; and a first value of the at least one metric is calculated for information representative of the IP data traffic occurring on the IP data network before the timestamp; and a second value of the at least one metric is calculated for information representative of the IP data traffic occurring on the IP data network after the timestamp.

3. The method of claim 2, wherein the first value and the second value of the at least one metric are compared, to measure the impact of the enforcement of the Policy and Charging Control rule on the IP data traffic occurring on the IP data network.

4. The method of claim 1, wherein the Policy and Charging Control rule is a candidate for enforcement to the IP data network; and the value of the at least one metric representative of the Policy and Charging Control rule is representative of the potential impact of the enforcement of the Policy and Charging Control rule on the IP data traffic occurring on the IP data network.

5. The method of claim 1, wherein the information representative of the IP data traffic occurring on the IP data network is processed by a processing unit at the analytic system to generate summarized records; the summarized records are memorized in a database at the analytic system; and the memorized summarized records are processed by an analytic engine at the analytic system to calculate the value of the at least one metric representative of the Policy and Charging Control rule.

6. The method of claim 1, wherein real time data is collected by means of at least one collector from the IP data traffic occurring on the IP data network, information representative of the IP data traffic occurring on the IP data network is extracted by the at least one collector from the real time data, and the information representative of the IP data traffic occurring on the IP data network is transmitted from the at least one collector to the analytic system.

7. The method of claim 1, wherein a combination of several Policy and Charging Control rules is analyzed to define at least one metric representative of the combination of the several Policy and Charging Control rules.

8. The method of claim 1, wherein processing at the analytic system the information representative of the IP data traffic occurring on the IP data network, to calculate a value of the at least one metric representative of the Policy and Charging Control rule, comprises processing additional information in conjunction with processing the information representative of the IP data traffic occurring on the IP data network; the additional information including information from a Subscriber Data Management server.

9. The method of claim 1, wherein a Policy and Charging Control rule consists in at least one attribute and at least one action; the at least one attribute being composed of a sub-attribute and a condition.

10. The method of claim 9, wherein a metric representative of a Policy and Charging Control rule consists in a measure and at least one characteristic of the measure; and analyzing a Policy and Charging Control rule to define at least one metric representative of the Policy and Charging Control rule consists in analyzing the pair of sub-attribute/condition composing the at least one attribute, and analyzing the at least one action, to generate at least one measure and at least one characteristic of the measure.

11. The method of claim 10, wherein the at least one attribute has one of the following types: users, devices, applications and protocols, time, and network.

12. A system for generating metrics representative of Policy and Charging Control (PCC) rules, the system comprising:
a PCC rules analyzer:
for analyzing a Policy and Charging Control rule to define at least one metric representative of the Policy and Charging Control rule; and
for transmitting the at least one metric representative of the Policy and Charging Control rule to an analytic system;
an analytic system:
for receiving the at least one metric representative of the Policy and Charging Control rule from the PCC rules analyzer;
for receiving information representative of an IP data traffic occurring on an IP data network; and
for processing the information representative of the IP data traffic occurring on the IP data network, to calculate a value of the at least one metric representative of the Policy and Charging Control rule.

13. The system of claim 12, wherein a timestamp of enforcement of the Policy and Charging Control rule to the IP data network is associated to the at least one metric representative of the Policy and Charging Control rule; and a first value of the at least one metric is calculated for information representative of the IP data traffic occurring on the IP data network before the timestamp; and a second value of the at least one metric is calculated for information representative of the IP data traffic occurring on the IP data network after the timestamp.

14. The system of claim 13, wherein the first value and the second value of the at least one metric are compared, to measure the impact of the enforcement of the Policy and Charging Control rule on the IP data traffic occurring on the IP data network.

15. The system of claim 12, wherein the Policy and Charging Control rule is a candidate for enforcement to the IP data network; and the value of the at least one metric representative of the Policy and Charging Control rule is representative of the potential impact of the enforcement of the Policy and Charging Control rule on the IP data traffic occurring on the IP data network.

16. The system of claim 12, wherein the analytic system includes:
a processing unit for processing the information representative of the IP data traffic occurring on the IP data network to generate summarized records;
a database for memorizing the summarized records; and
an analytic engine for processing the memorized summarized records to calculate the value of the at least one metric representative of the Policy and Charging Control rule.

17. The system of claim 12, wherein at least one collector:
collects real time data from the IP data traffic occurring on the IP data network,
extracts information representative of the IP data traffic occurring on the IP data network from the real time data, and
transmits the information representative of the IP data traffic occurring on the IP data network to the analytic system.

18. The system of claim 12, wherein a combination of several Policy and Charging Control rules is analyzed to define at least one metric representative of the combination of the several Policy and Charging Control rules.

19. The system of claim 12, wherein processing at the analytic system the information representative of the IP data traffic occurring on the IP data network, to calculate a value of the at least one metric representative of the Policy and Charging Control rule, comprises processing additional information in conjunction with processing the information representative of the IP data traffic occurring on the IP data network; the additional information including information from a Subscriber Data Management server.

20. The system of claim 12, wherein a Policy and Charging Control rule consists in at least one attribute and at least one action; the at least one attribute being composed of a sub-attribute and a condition.

21. The system of claim 20, wherein a metric representative of a Policy and Charging Control rule consists in a measure and at least one characteristic of the measure; and analyzing a Policy and Charging Control rule to define at least one metric representative of the Policy and Charging Control rule consists in analyzing the pair of sub-attribute/condition composing the at least one attribute, and analyzing the at least one action, to generate at least one measure and at least one characteristic of the measure.

22. The system of claim 21, wherein the at least one attribute has one of the following types: users, devices, applications and protocols, time, and network.
